(19) United States
(12) Patent Application Publication
(10) Pub. No.: US 2026/0321925 A1
(43) Pub. Date: Oct. 15, 2026

(54) CONDUCTIVE MODULE

(71) Applicants: YAZAKI CORPORATION, Tokyo (JP); Prime Planet Energy & Solutions, Inc., Tokyo (JP)

(72) Inventors: Yasuhiro Kominato, Makinohara-shi (JP); Katsunori Sato, Makinohara-shi (JP); Go Yamashiro, Miyoshi-shi (JP)

(21) Appl. No.: 19/645,052

(22) Filed: Apr. 10, 2026

(30) Foreign Application Priority Data
Apr. 14, 2025 (JP) 2025-066084

(51) Int. Cl. H01M 50/569; H01M 50/503; H01M 50/507; H01M 50/519; H01M 50/588; H01M 50/591

(52) U.S. Cl. CPC H01M 50/569; H01M 50/503; H01M 50/507; H01M 50/519; H01M 50/588; H01M 50/591

(57) ABSTRACT

A conductive module includes a busbar and a flat wiring material having flexibility and electrically connected to the busbar. The flat wiring material has a trunk portion extending along an extension direction of a battery module and a branch portion protruding from an end of the trunk portion in a width direction intersecting the extension direction, and electrically connected to the busbar. The branch portion has a plurality of first sections spaced apart from each other along the width direction and extending along the extension direction, and a curved second section connecting the first sections to each other along the width direction. The branch portion has a folded shape expandable and contractible along the width direction.

### CROSS-REFERENCE TO RELATED APPLICATION(S)

The present application claims priority to and incorporates by reference the entire contents of Japanese Patent Application No. 2025-066084 filed in Japan on Apr. 14, 2025.

### BACKGROUND OF THE INVENTION

### 1. Field of the Invention

The present invention relates to a conductive module.

### 2. Description of the Related Art

As a conventional technology related to conductive modules, for example, Japanese Patent Application Laid-open No. JP 2015 - 049 931 A discloses a battery internal wiring module in which busbars connected to electrode posts of battery cells are held on a wiring substrate, wherein the wiring substrate has a trunk portion extending in a direction in which the battery cells are aligned, a plurality of branch portions extending from both sides of the trunk portion, and a plurality of busbar holding portions formed at the distal ends of the branch portions to hold the busbars individually. A displacement permitting space is provided between the busbar holding portions to disconnect the adjacent busbar holding portions from each other and permit displacement. At least the branch portions are flexible. The trunk portion has a wiring guide that leads a voltage monitoring line having one end connected to the busbar and holds the voltage monitoring line.

In the above conventional battery internal wiring module, for example, the branch portions formed with electric wires are expandable and contractible along the width direction, but there is room for further improvement in terms of properly absorbing the tolerance between the trunk portion and the busbars.

### SUMMARY OF THE INVENTION

The present invention is made in view of the above circumstance, and an object of the present invention is to provide a conductive module that can properly absorb the tolerance between the trunk portion and the busbars.

In order to achieve the above mentioned object, a conductive module according to one aspect of the present invention includes a busbar electrically connected to an electrode terminal of a battery cell that constitutes a battery module; and a flat wiring material having flexibility and electrically connected to the busbar, wherein the flat wiring material has a trunk portion extending along an extension direction of the battery module, and a branch portion protruding from an end of the trunk portion in a width direction intersecting the extension direction, the branch portion being electrically connected to the busbar, and the branch portion has a plurality of first sections spaced apart from each other along the width direction and extending along the extension direction, and a curved second section connecting the first sections to each other along the width direction, the branch portion having a folded shape expandable and contractible along the width direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a conductive module according to an embodiment;

FIG. 2 is an exemplary perspective view of a battery module and busbars to which the conductive module according to the embodiment is applied;

FIG. 3 is an exemplary exploded perspective view of the conductive module according to the embodiment;

FIG. 4 is an exemplary plan view of the conductive module according to the embodiment with a cover removed;

FIG. 5 is an enlarged view of the vicinity of a flat wiring material in FIG. 4;

FIG. 6 is an exemplary enlarged view of a branch portion at an end in an extension direction of the flat wiring material in FIG. 5; and

FIG. 7 is an exemplary enlarged view of a branch portion different from the branch portion at an end in the extension direction of the flat wiring material in FIG. 5.

### DETAILED DESCRIPTION OF THE PREFERRED EMBODIMENTS

Embodiments according to the present invention will be described in detail below based on the drawings. The following embodiments are not intended to limit this invention. The components in the following embodiments include those that can be replaced and readily conceived by those skilled in the art or are substantially the same. In the present description, ordinal numbers are used only to distinguish components, members, sections, positions, directions, and the like, and do not indicate order or priority.

### Embodiments

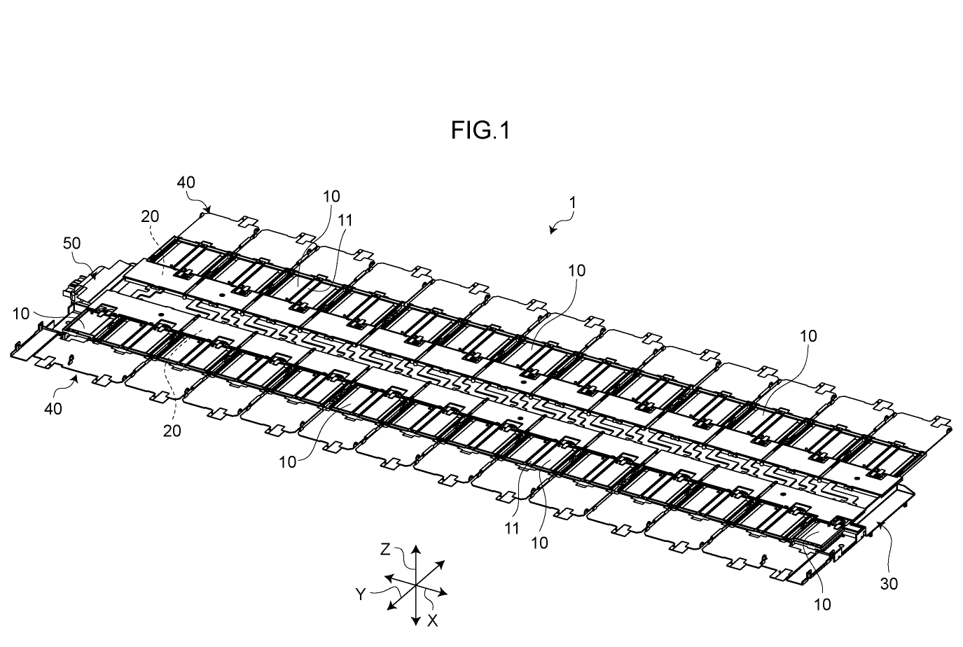

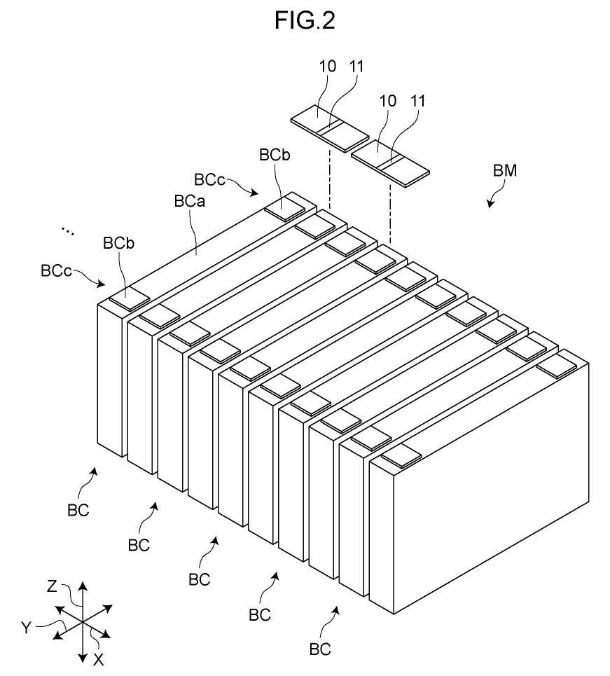

FIG. 1 is a perspective view of a conductive module 1 according to an embodiment. For example, the conductive module 1 of the present embodiment illustrated in FIG. 1 is assembled to a battery module BM in which a plurality of battery cells BC (FIG. 2) are arranged, and is electrically connected to the battery cells BC in the battery module BM. The conductive module 1 also electrically connects the battery module BM to a battery monitoring unit through a connector 50, thereby allowing the battery monitoring unit to monitor a battery state of the battery cells BC. The conductive module 1 and the battery module BM constitute a battery pack. The battery pack is installed, for example, in a vehicle (BEV: Battery Electric Vehicle, HEV: Hybrid Electric Vehicle, etc.) with a rotating machine as a drive source, and is used to supply power to the rotating machine.

In the following description, first, second, and third directions intersect each other, in which the first direction is referred to as "extension direction X", the second direction is referred to as "width direction Y", and the third direction is referred to as "assembly direction Z". Here, the extension direction X, the width direction Y, and the assembly direction Z are approximately orthogonal to each other. The extension direction X typically corresponds to the extension direction (longitudinal direction) of the conductive module 1, the extension direction (longitudinal direction) of the battery module BM, the array direction of a plurality of battery cells BC, and the like. The width direction Y typically corresponds to the width direction (lateral direction) of the conductive module 1 and the battery module BM, and the like. The assembly direction Z typically corresponds to the height direction (vertical direction) of the conductive module 1 and the battery module BM, the assembly direction of a case 30 and a cover 40 described below, and the like. Unless otherwise noted, each direction used in the following description is described as the direction in a state in which the conductive module 1 is assembled to the battery module BM.

FIG. 2 is a perspective view of the battery module BM and busbars 10 to which the conductive module 1 is applied. As illustrated in FIG. 2, the battery cells BC each have a cell body BCa, and positive and negative electrode terminals BCb. In the battery module BM, a plurality of battery cells BC are arranged in a row along the extension direction X. The battery module BM includes a first electrode terminal group BCc in which the electrode terminals BCb of the battery cells BC are arranged along the extension direction X on one side in the width direction Y, and a second electrode terminal group BCc in which the electrode terminals BCb of the battery cells BC are arranged along the extension direction X on the other side in the width direction Y.

For example, the battery cell BC has the cell body BCa formed in a rectangular parallelepiped shape with six outer wall surfaces. In a plurality of battery cells BC, the cell bodies BCa adjacent to each other in the extension direction X are disposed such that their respective outer wall surfaces face each other. For example, in the battery cell BC, the positive and negative electrode terminals BCb are disposed on one of the six outer wall surfaces of the cell body BCa or separately disposed on two of the six outer wall surfaces of the cell body BCa. Here, each battery cell BC has positive and negative electrode terminals BCb on one of the six outer wall surfaces of the cell body BCa. Thus, in the battery module BM, two electrode terminal groups BCc are provided on one outer wall surface.

The electrode terminal BCb is formed, for example, in the shape of a flat plate and is directly electrically connected to the busbar 10 described below by laser welding or the like. However, the electrode terminal BCb may be formed in the shape of a polar column with a male screw portion. In this case, the busbar 10 is screwed and secured to the electrode terminal BCb by screwing a female threaded member to the male screw portion of the electrode terminal BCb.

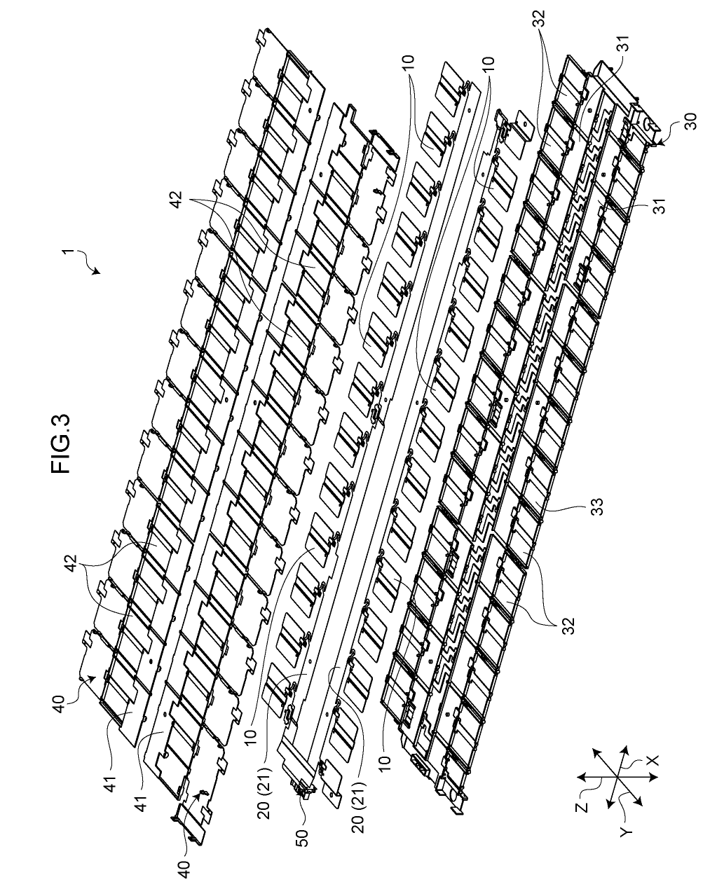

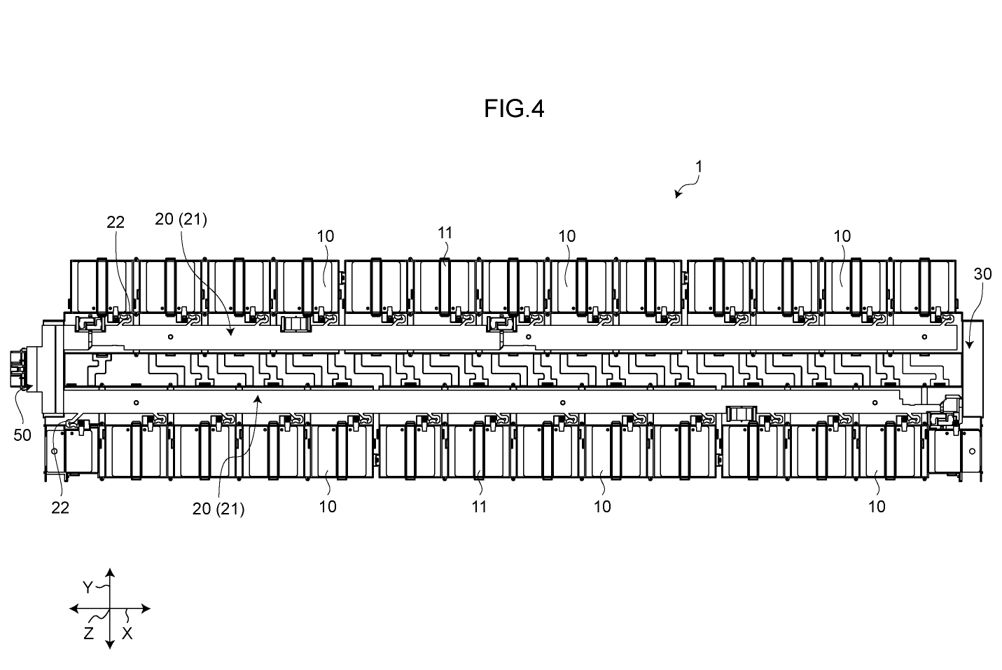

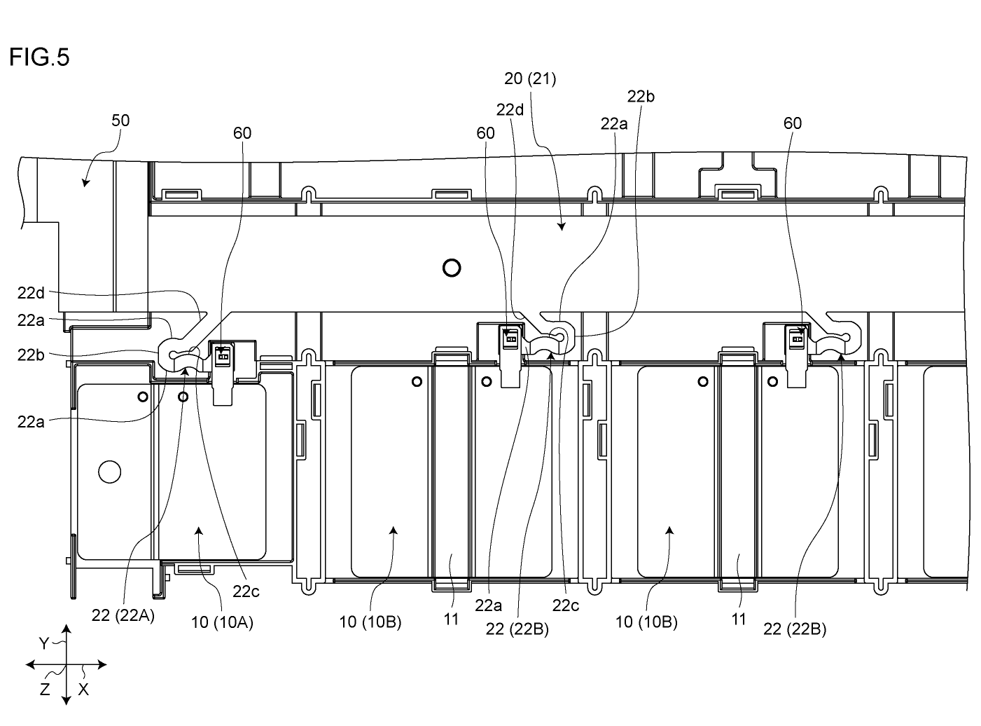

FIG. 3 is an exploded perspective view of the conductive module 1, FIG. 4 is a plan view of the conductive module 1 with the cover 40 removed, and FIG. 5 is an enlarged view of the vicinity of a flat wiring material 20 in FIG. 4. As illustrated in FIGS. 3 to 5, the conductive module 1 includes, for example, a plurality of the busbars 10, a pair of the flat wiring materials 20, the case 30, the cover 40, the connector 50, and a plurality of intermediate terminals 60. The busbars 10 are electrically connected to the electrode terminals BCb of the battery cells BC constituting the battery module BM. The busbar 10 is a metal plate-shaped conductive component, which is, for example, press-formed from a metal plate as a base material. The busbar 10 illustrated here is formed as a rectangular flat plate and has a recess 11 recessed along the assembly direction Z in the center in the extension direction X. The busbar 10 is configured to be deformable to conform along the extension direction X by means of the recess 11, for example, when the battery cell BC is deformed along the extension direction X due to thermal expansion or the like.

The busbars 10 include, for example, a pair of first busbars 10A provided at both ends in the extension direction X and electrically connected to the electrode terminals BCb each serving as a total positive electrode or a total negative electrode in the battery module BM, and a plurality of second busbars 10B electrically connected to the electrode terminals BCb of a pair of battery cells BC adjacent to each other in the extension direction X in the battery module BM. FIG. 5 illustrates one of the pair of first busbars 10A that is provided at one end in the extension direction X. In the present embodiment, the first busbar 10A has a smaller width along the width direction Y than the other second busbars 10B. With this configuration, the first busbar 10A is located farther along the width direction Y from a trunk portion 21 described below of the flat wiring material 20 than the other second busbars 10B.

The flat wiring material 20 is a wiring material that constitutes a wire harness WH, and includes, for example, a flexible printed circuit (FPC) or a flexible flat cable (FFC). The flat wiring material 20 is a flexible (bendable), flat wiring material which is thin along the assembly direction Z. In the present embodiment, the conductive module 1 has the pair of flat wiring materials 20 spaced apart from each other along the width direction Y, corresponding to the pair of electrode terminal groups BCc of the battery module BM and the busbars 10 described above. The pair of flat wiring materials 20 each include, for example, the trunk portion 21 and a branch portion 22. The trunk portion 21 is a portion of the flat wiring material 20 that is formed as a rectangular flat plate extending horizontally along the extension direction X. The trunk portion 21 constitutes the main body of the flat wiring material 20. The branch portion 22 is a portion of the flat wiring material 20 that protrudes from one end in the width direction Y of the trunk portion 21 and is electrically connected to the busbar 10. In the present embodiment, the flat wiring material 20 has a plurality of the branch portions 22 spaced apart from each other along the extension direction X, corresponding to the first busbars 10A and the second busbars 10B as a plurality of the busbars 10.

The flat wiring material 20 includes, for example, a base film, a wiring pattern, and a coverlay. The base film is a flexible base material that defines the overall shape of the flat wiring material 20. The base film is formed, for example, of a polyimide resin with excellent heat resistance. The wiring pattern is laminated on a surface of the base film and constitutes a plurality of conductor circuit portions (pattern layers). The wiring pattern is, for example, formed of a conductive material such as copper foil and printed as a printed circuit on a surface of the base film. The coverlay is laminated over the surface of the base film via an adhesive or the like, and functions as a protective layer to protect the conductor circuit portions of the wiring pattern and the like.

The case 30 (see FIG. 3) includes, for example, a case bottom wall 31 and a plurality of case insertion holes 32. The case bottom wall 31 supports the busbars 10 and the flat wiring materials 20 from the other side (bottom side) in the assembly direction Z. The case bottom wall 31 is formed as an approximately rectangular flat plate extending horizontally along the extension direction X. The case insertion holes 32 are through holes through the case bottom wall 31 along the assembly direction Z and are spaced apart from each other along the extension direction X. The electrode terminals BCb of the battery cells BC described above are inserted into the case insertion holes 32 along the assembly direction Z. The busbars 10 are attached to the electrode terminals BCb of the battery cells BC exposed from the case insertion holes 32. The case 30 is formed, for example, of an insulating resin material.

The cover 40 is, for example, a combination of a plurality of components each including a cover bottom wall 41 and a plurality of cover insertion holes 42. The cover bottom wall 41 is assembled along the assembly direction Z to the case 30 and supports the busbars 10 and the flat wiring material 20 from one side (top side) in the assembly direction Z. The cover bottom wall 41 is formed as an approximately rectangular flat plate extending horizontally along the extension direction X. The cover insertion holes 42 are through holes passing through the cover bottom wall 41 along the assembly direction Z and are spaced apart from each other along the extension direction X. The busbars 10 described above are inserted into the cover insertion holes 42 along the assembly direction Z. The cover 40 is formed, for example, of an insulating resin material.

The connector 50 is provided, for example, at one end in the extension direction X of the trunk portion 21 in the flat wiring material 20, and is electrically connected to the battery monitoring unit that monitors a battery state of the battery cells BC described above. The connector 50 is electrically continuous to the wiring pattern of the flat wiring material 20. A plurality of conductor circuit portions formed with the wiring pattern may function, for example, as any of signal circuits, signal GND circuits, and ground circuits for power. The signal circuit is, for example, a circuit that transmits communication signals between the battery cell BC and the battery monitoring unit. The signal GND circuit is a circuit that accompanies the signal circuit and is electrically continuous between the battery cell BC and the battery monitoring unit to match a reference potential for circuit operation. The ground circuit for power is a circuit that grounds a power system between the battery cell BC and the battery monitoring unit.

The intermediate terminals 60 (see FIG. 5) are each provided, for example, at a distal end 22e of the branch portion 22 in the flat wiring material 20 and is electrically connected to the busbar 10. In the present embodiment, the flat wiring material 20 has the plurality of intermediate terminals 60 respectively corresponding to the plurality of branch portions 22. The intermediate terminals 60 are bonded to the busbars 10, for example, by soldering. In the present embodiment, the intermediate terminals 60 are provided at the branch portions 22 of the flat wiring material 20, by way of example. However, the intermediate terminals 60 are not limited to this example. For example, the branch portions 22 and the busbars 10 may be directly electrically connected without the intermediate terminals 60 in the flat wiring material 20.

Here, in the present embodiment, the branch portions 22 of the flat wiring material 20 are each formed in a folded shape expandable and contractible along the width direction Y. Specifically, the branch portions 22 each include a plurality of first sections 22a, a second section 22b, and a third section 22d. The first sections 22a are sections of the branch portion 22 that are spaced apart from each other along the width direction Y and extend along the extension direction X. In the present embodiment, the branch portion 22 has two first sections 22a spaced apart from each other along the width direction Y, and the two first sections 22a are located such that they overlap each other along the width direction Y. The second section 22b is a section of the branch portion 22 that connects the first sections 22a to each other along the width direction Y and is curved in a convex state along the extension direction X. In other words, the second section 22b allows one of the two first sections 22a that extends toward one end in the extension direction X to be folded back toward the other end of the extension direction X. The third section 22d is a section of the branch portion 22 that connects the trunk portion 21 to one of the two first sections 22a and constitutes a proximal end of the branch portion 22. In the present embodiment, the third section 22d is inclined relative to the width direction Y.

The branch portions 22 include, for example, a pair of first branch portions 22A provided at both ends in the extension direction X corresponding to the pair of first busbars 10A described above, and a plurality of second branch portions 22B provided corresponding to the plurality of second busbars 10B. FIG. 5 illustrates one of the pair of first branch portions 22A that is provided at one end in the extension direction X. The first branch portion 22A is configured, for example, such that its length along the width direction Y in a free state (not elastically deformed) is the same as the length along the width direction Y in a free state of the other second branch portion 22B. In the present embodiment, the first branch portion 22A is connected to the first busbar 10A in a more expanded state along the width direction Y than the second branch portion 22B. This configuration absorbs the tolerance between the trunk portion 21 and the busbars 10 due to the size difference of the first busbars 10A from the second busbars 10B described above.

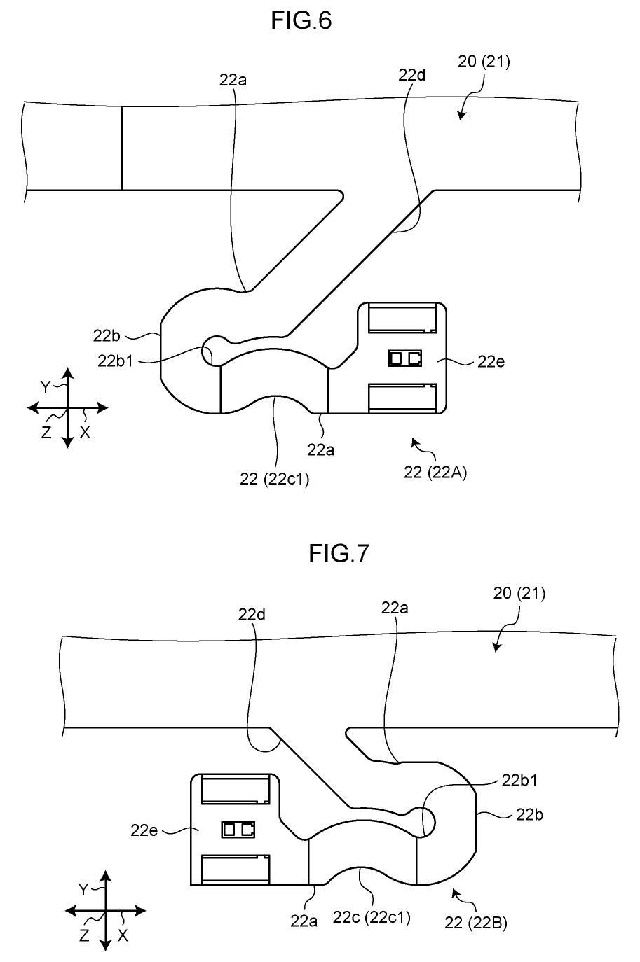

FIG. 6 is an enlarged view of the first branch portion 22A at one end in the extension direction X of the flat wiring material 20 in FIG. 5, and FIG. 7 is an enlarged view of the second branch portion 22B different from the first branch portion 22A of the flat wiring material 20 in FIG. 5. As illustrated in FIGS. 6 and 7, in the present embodiment, the first branch portion 22A is formed in an inverted shape (line symmetry) along the extension direction X with respect to the second branch portion 22B. In other words, the first branch portion 22A has the second section 22b curved in a convex state toward one end in the extension direction X, and the second branch portion 22B has the second section 22b curved in a convex state toward the other end in the extension direction X. In other words, the second section 22b of the first branch portion 22A allows one of the two first sections 22a that extends toward one end in the extension direction X to be folded back toward the other end in the extension direction X, and the second section 22b of the second branch portion 22B allows one of the two first sections 22a that extends toward the other end in the extension direction X to be folded back toward one end in the extension direction X.

In the present embodiment, the first branch portion 22A and the second branch portion 22B each have a serpentine portion 22c. The serpentine portion 22c is provided at least at one of the first sections 22a of each of the first branch portion 22A and the second branch portion 22B that is located closer to the distal end 22e. The serpentine portion 22c is a section curved along the width direction Y. In the present embodiment, the serpentine portion 22c is curved in a convex state toward one end in the width direction Y (the top side in FIGS. 6 and 7). In other words, the serpentine portion 22c allows a section of the serpentine portion 22c that extends toward one end in the width direction Y to be folded back toward the other end in the width direction Y. The serpentine portion 22c is formed in an arc shape (semicircular shape) when viewed from the assembly direction Z. The serpentine portion 22c functions as a section that suppresses the concentration of stress on a bent portion 22b1 of the second section 22b, for example, when stress is transmitted from the distal end 22e due to vibration or thermal expansion of the battery cell BC.

In other words, if the first branch portion 22A and the second branch portion 22B do not have the serpentine portions 22c, and the respective first sections 22a are formed linearly along the extension direction X, the stress transmitted from the respective distal ends 22e may concentrate on the bent portions 22b1 of the second sections 22b. In this respect, according to the present embodiment, the first branch portion 22A and the second branch portion 22B have the serpentine portions 22c, so that when stress is transmitted along the extension direction X from the respective distal ends 22e, the stress can be distributed to the bent portions 22b1 of the second sections 22b and bent portions 22c1 of the serpentine portions 22c. This configuration improves the reliability of the electrical connection between the first and second branch portions 22A and 22B and the first and second busbars 10A and 10B.

As described above, in the conductive module 1 of the present embodiment, the branch portion 22 has a plurality of first sections 22a spaced apart from each other along the width direction Y and extending along the extension direction X, and the curved second section 22b connecting the first sections 22a to each other along the width direction Y. The branch portion 22 is formed in a folded shape expandable and contractible along the width direction Y. With this configuration, the conductive module 1, for example, allows the branch portion 22 to expand and contract along the width direction Y according to the amount of expansion and contraction by means of the folded shape, so that the conductive module 1 can absorb the tolerance between the trunk portion 21 and the busbars 10 while suppressing the increase in size of the branch portion 22 and thus the flat wiring material 20 along the width direction Y. As a result, the conductive module 1 can properly absorb the tolerance between the trunk portion 21 and the busbars 10.

In the conductive module 1 of the present embodiment, at least one first section 22a located closer to the distal end 22e of the branch portion 22 has the serpentine portion 22c curved in a convex state along the width direction Y. With this configuration, the conductive module 1 can suppress the concentration of stress on the bent portion 22b1 of the second section 22b, which occurs when stress is transmitted from the distal end 22e of the branch portion 22, for example, due to vibration or thermal expansion of the battery cell BC, and can distribute the stress to the bent portion 22c1 of the serpentine portion 22c. As a result, the conductive module 1 can improve the reliability of the electrical connection between the branch portion 22 and the busbars 10.

In the conductive module 1 of the present embodiment, the first busbar 10A as at least one busbar 10 located at an end in the extension direction X is located farther along the width direction Y from the trunk portion 21 than the second busbar 10B as the other busbar 10, and the first branch portion A as one branch portion 22 corresponding to the first busbar 10A is connected to the first busbar 10A in a more expanded state along the width direction Y than the second branch portion 22B as the other branch portion 22. With this configuration, the conductive module 1 can properly absorb the tolerance between the trunk portion 21 and the busbars 10 (the first busbars 10A and the second busbars 10B), for example, even when the first busbars 10A and the second busbars 10B which are busbars 10 with different sizes are provided.

The conductive module 1 of the present embodiment includes: the insulating case 30 and the cover 40 assembled to each other along the assembly direction Z to support the busbars 10 and the flat wiring materials 20 such that the branch portions 22 are expandable and contractible along the width direction Y; the connector 50 provided at an end in the extension direction X of the trunk portion 21 and electrically connected to the battery monitoring unit that monitors a battery state of the battery cells BC; and the intermediate terminal 60 provided at the distal end 22e of the branch portion 22 and electrically connected to the busbar 10. With this configuration, the conductive module 1, for example, interposed between the battery cells BC of the battery module BM and the battery monitoring unit, can properly absorb the tolerance between the trunk portion 21 and the busbars 10.

In the present embodiment, the branch portion 22 is formed in a folded shape having two first sections 22a and a curved second section 2b connecting the two first sections 22a to each other, by way of example. However, the branch portion 22 is not limited to this example and may be formed, for example, in a folded shape (zigzag pattern shape, bellows shape) having three or more first sections 22a arranged along the width direction Y and two or more (a plurality of) second sections 22b connecting two adjacent first sections 22a to each other in the width direction Y.

The conductive module according to the present embodiment achieves the effect of properly absorbing the tolerance between the trunk portion and the busbars.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module comprising:
a busbar electrically connected to an electrode terminal of a battery cell that constitutes a battery module; and
a flat wiring material having flexibility and electrically connected to the busbar, wherein
the flat wiring material has a trunk portion extending along an extension direction of the battery module, and a branch portion protruding from an end of the trunk portion in a width direction intersecting the extension direction, the branch portion being electrically connected to the busbar, and
the branch portion has a plurality of first sections spaced apart from each other along the width direction and extending along the extension direction, and a curved second section connecting the first sections to each other along the width direction, the branch portion having a folded shape expandable and contractible along the width direction.

2. The conductive module according to claim 1, wherein
at least one of the first sections that is located closer to a distal end of the branch portion has a serpentine portion curved along the width direction.

3. The conductive module according to claim 1, wherein
the conductive module comprises a plurality of the busbars corresponding to the electrode terminals of a plurality of the battery cells arranged along the extension direction,
the flat wiring material has a plurality of the branch portions corresponding to the busbars,
at least one busbar that is located at an end in the extension direction is located farther from the trunk portion along the width direction than other busbars, and
one branch portion that corresponds to the busbar located at an end in the extension direction is connected to the busbar in a more expanded state along the width direction than other branch portions.

4. The conductive module according to claim 2, wherein
the conductive module comprises a plurality of the busbars corresponding to the electrode terminals of a plurality of the battery cells arranged along the extension direction,
the flat wiring material has a plurality of the branch portions corresponding to the busbars,
at least one busbar that is located at an end in the extension direction is located farther from the trunk portion along the width direction than other busbars, and
one branch portion that corresponds to the busbar located at an end in the extension direction is connected to the busbar in a more expanded state along the width direction than other branch portions.

5. The conductive module according to claim 1, further comprising:
an insulating case and cover assembled to each other along an assembly direction intersecting the extension direction and the width direction, the case and the cover supporting the busbar and the flat wiring material in a state where the branch portion is expandable and contractible along the width direction;
a connector disposed at an end in the extension direction of the trunk portion in the flat wiring material and electrically connected to a battery monitoring unit that monitors a battery state of the battery cell; and
an intermediate terminal disposed at a distal end of the branch portion in the flat wiring material and electrically connected to the busbar.

6. The conductive module according to claim 2, further comprising:
an insulating case and cover assembled to each other along an assembly direction intersecting the extension direction and the width direction, the case and the cover supporting the busbar and the flat wiring material in a state where the branch portion is expandable and contractible along the width direction;
a connector disposed at an end in the extension direction of the trunk portion in the flat wiring material and electrically connected to a battery monitoring unit that monitors a battery state of the battery cell; and
an intermediate terminal disposed at the distal end of the branch portion in the flat wiring material and electrically connected to the busbar.
